(19) United States
(12) Patent Application Publication
(10) Pub. No.: US 2022/0373276 A1
(43) Pub. Date: Nov. 24, 2022

(54) HEAT EXCHANGER, COATING FOR COATING HEAT EXCHANGER, AND HEAT MANAGEMENT SYSTEM

(71) Applicant: Hangzhou Sanhua Research Institute Co., Ltd., Hangzhou (CN)

(72) Inventors: Hai HUANG, Hangzhou (CN); Ming XUE, Hangzhou (CN); Bei HE, Hangzhou (CN); Jianhua TANG, Hangzhou (CN); Linjie HUANG, Hangzhou (CN)

(21) Appl. No.: 17/815,190

(22) Filed: Jul. 26, 2022

Related U.S. Application Data
(63) Continuation-in-part of application No. PCT/CN2021/142617, filed on Dec. 29, 2021.

(30) Foreign Application Priority Data
Jan. 8, 2021 (CN) 202110025293.9

(51) Int. Cl. F28F 19/02; C09D 5/14; C09D 5/02; C09D 1/00; C09D 7/20; A01N 25/12; A01N 25/08; A01N 59/00; A01P 1/00

(52) U.S. Cl. CPC F28F 19/02; C09D 5/14; C09D 5/024; C09D 1/00; C09D 7/20; A01N 25/12; A01N 25/08; A01N 59/00; A01P 1/00

(57) ABSTRACT

A heat exchanger includes a metal base defining a heat exchange channel for flowing at least one of a refrigerant and a coolant therein, and a coating layer coated at least a part of an outer surface of the metal base. The coating layer includes sol particles and an antibacterial material, where the sol particles include silica. The antibacterial material includes a rare earth element oxide. By combining the antibacterial agent containing the rare earth element oxide with sol, the advantages of each component can be fully utilized. On the one hand, it is easier to attach the antibacterial material via the sol, and on the other hand a surface of the metal base of the heat exchanger can have a good antibacterial and mold-inhibiting effects, which is beneficial to cost reduction.

The present disclosure claims priority to Chinese Patent Application No. 202110025293.9, entitled “COMPOSITE MATERIAL, PREPARATION METHOD THEREOF, HEAT EXCHANGER AND THERMAL MANAGEMENT SYSTEM” and filed with the China National Intellectual Property Administration on Jan. 8, 2021, the entire contents of which are incorporated herein by reference. Furthermore, the present disclosure claims priority to PCT Application No. PCT/CN2021/142617, entitled “HEAT EXCHANGER, COATING FOR COATING HEAT EXCHANGER, AND HEAT MANAGEMENT SYSTEM” and filed with the China National Intellectual Property Administration on Dec. 29, 2021, the entire contents of which are incorporated herein by reference.

### TECHNICAL FIELD

The present disclosure relates to the technical field of materials and heat exchange and in particular, to a heat exchanger, a coating material used to the heat exchanger, and a thermal management system.

### BACKGROUND

Bacteria, molds, and the like are common in daily life, and they are often attached to the micro-particles in the air, and flow with the air. In related technologies, air circulation is used to achieve a cooling or heating function in an air-conditioning system. After a period of use, bacteria, molds, viruses or dust in the air may be attached to the surface of a heat exchanger. The above impurities will affect the working efficiency of the heat exchanger and the health of the user as being accumulated to a certain amount.

Most of air conditioners in related technologies do not have antibacterial functions. How to effectively slow down the growth of impurities such as bacteria and molds in the heat exchanger, correspondingly reduce the impact on the working efficiency of the heat exchanger or the user's health, and improve the user's experience have become urgent technical problems to be solved.

### SUMMARY

The present disclosure is intended to solve at least one of the technical problems existing in the prior art. For this purpose, the present disclosure provides a heat exchanger, a coating material used to the heat exchanger and a thermal management system.

According to one aspect of the present disclosure, a heat exchanger is provided, the heat exchanger includes a metal base defining a heat exchange channel for flowing at least one of a refrigerant and a coolant therein, the heat exchanger further includes a coating layer coated at least a part of an outer surface of the metal base, the coating layer includes sol particles and an antibacterial material, and the sol particles include silica, the antibacterial material including a rare earth element oxide.

In the heat exchanger of the present disclosure, the coating layer includes sol particles and an antibacterial material, wherein the sol particles include silica, and the antibacterial material includes a rare earth element oxide. Therefore, by using the antibacterial material containing the rare earth element oxide in combination with the silica sol, the advantages of each component can be fully utilized, which is beneficial for attachment to a surface of the metal base on the one hand, and on the other hand, the surface of the metal base of the heat exchanger can also have the effect of inhibiting the growth of substances such as bacteria and molds.

According to another aspect of the present disclosure, a coating material used to a heat exchanger is provided, the coating material includes a sol and an antibacterial material, the sol has sol particles, and the sol particles include silica, and the antibacterial material includes a rare earth element oxide.

The coating material of the present disclosure includes a sol and an antibacterial material, wherein the sol includes a silica sol, and the antibacterial material includes a rare earth element oxide. Therefore, by using the antibacterial material containing the rare earth element oxide in combination with the silica sol, the advantages of each component can be fully utilized, and a surface of a coated object can be attached easily while inhibiting the growth of bacteria and molds.

According to a third aspect of the present disclosure, a thermal management system is provided, the thermal management system includes a compressor, a first heat exchanger, a throttling device and a second heat exchanger. When a refrigerant flows in the thermal management system, the refrigerant flows into the first heat exchanger through the compressor, and then flows into the throttling device after exchanging heat in the first heat exchanger, and then flows into the second heat exchanger, and then flows into the compressor after exchanging heat in the second heat exchange; and at least one of the first heat exchange and the second heat exchanger is the above-mentioned heat exchanger.

The thermal management system of the present disclosure includes the above-mentioned heat exchanger, the coating layer on the surface of the metal base of the heat exchanger includes the sol particles and the antibacterial material, wherein the sol particles include silica, and the antibacterial material includes a rare earth element oxide. Therefore, by using the antibacterial material containing the rare earth element oxide in combination with the silica sol, the advantages of each component can be fully utilized, which is beneficial to attachment to the surface of the metal base on one hand, and on the other hand, the surface of the metal base of the heat exchanger can also have the effect of inhibiting the growth of substances such as bacteria and molds.

The additional aspects and advantages of the present disclosure will be set forth in part in the following description and become apparent in part from the following description or be understood through the practice of the present disclosure.

### BRIEF DESCRIPTION OF DRAWINGS

FIG. 1 is a schematic structural diagram of a heat exchanger according to an exemplary embodiment of the present disclosure;

FIG. 2 is a schematic cross-sectional view of a fin part of a heat exchanger according to an exemplary embodiment of the present disclosure;

FIG. 3 is a schematic structural diagram of a thermal management system according to an embodiment of the present disclosure;

FIG. 4 shows a picture of a sample of Example 1 of the present disclosure after a mold-inhibiting property test for 28 days; and

FIG. 5 shows a picture of a sample from Comparative Example 1 of the present disclosure after a mold-inhibiting property test for 28 days.

### REFERENCE NUMERALS

100—a heat exchanger; 10—a header; 11—a coating layer; 12—a heat exchange tube; 13—a fin; 1000—a thermal management system; 1—a compressor; 2—a first heat exchanger; 3—a throttling device; 4—a second heat exchanger; and 5—a reversing device.

### DESCRIPTION OF EMBODIMENTS

For clear description of the objectives, technical solutions and advantages of the present disclosure, the technical solution of the present disclosure will be described clearly and completely below in combination with embodiments of the present disclosure. It is apparent that the described embodiments are some of, not all the embodiments of the present disclosure. All other embodiments obtained by those skilled in the art based on the technical solutions and the embodiments of the present disclosure without creative efforts shall fall within the scope of the present disclosure. Those examples without specific conditions are generally implemented under conventional conditions or conditions recommended by the manufacturers. The reagents or instruments used without specifying the manufacturers are all conventional products that can be purchased commercially.

The endpoints of the ranges and any values disclosed herein are not limited to the precise ranges or values, and these ranges or values should be understood to include values close to these ranges or values. For numerical ranges, one or more new numerical ranges may be obtained by combining the endpoint values of each range, by combining the endpoint values of each range with individual point values, or by combining the individual point values with each other.

It should be noted that the term “and/or” or “/” used herein refers only to describing an association relationship between associated objects, and indicating that there may be three relationships, for example, A and/or B may indicate three cases: only A exists, A and B exist at the same time, and only B exists. The singular forms “a”, “said” and “the” as used in the embodiments of the present disclosure and the appended claims are also intended to include plural forms unless otherwise other meanings are explicitly indicated in the context.

In the description of the present disclosure, a list of items following the term “at least one of” or other similar terms may mean any combination of listed items. For example, if items A and B are listed, the phrase “at least one of A and B” means A only; B only; or A and B. In another example, if items A, B, and C are listed, the phrase “at least one of A, B, and C” means A only; B only; C only; or A and B (excluding C); A and C (excluding B); B and C (excluding A); or all of A, B, and C. Item A may include a single element or multiple elements. Item B may include a single element or multiple elements. Item C may include a single element or multiple elements. Furthermore, the term “at least part of a surface”, or other similar terms are used to mean any part of the surface of the component or the entire surface of the component. For example, at least part of the surface of the heat exchanger refers to a certain part or parts of the surface of the heat exchanger, or the entire surface of the heat exchanger.

In a specific embodiment, the present disclosure will be further described in detail below through specific embodiments.

In related technologies, a micro-channel heat exchanger is a highly efficient heat exchange device developed in the 1990s and may be widely used in the fields of chemical, energy, environmental and the like. As compared with devices of conventional sizes, the micro-channel heat exchanger has many different characteristics such as small size, light weight, high efficiency, high strength, and the like. Micro-channel technology has also triggered technological innovations in the fields of thermal management systems for new energy vehicles, household air conditioners, commercial air conditioners, and refrigeration devices, to improve efficiency and reduce emissions.

In the related art, antibacterial agents mainly work by inhibiting and blocking the reproduction of bacteria. The antibacterial agents are mainly divided into three categories: inorganic antibacterial agents, organic antibacterial agents and natural antibacterial agents. The organic antibacterial agents, such as quaternary ammonium salts, biguanides, phenols, and the like, have the advantage of quick effect, but shows short acting time, poor heat resistance and toxicity. The natural antibacterial agents, such as chitosan and chitin, have the advantage of non-toxicity, but they are difficult to extract and have poor heat resistance. The inorganic antibacterial agents, such as nano-silver, metal ions and their oxides, which have the advantages of broad-spectrum antibacterial properties, high safety, good thermal stability, and low possibility of drug resistance, have been widely used in the fields of medical treatment, sanitary ware, kitchen ware, electrical appliances and others. However, their cost is high cost, and they can hardly achieve good antibacterial and mold-inhibiting effects on heat exchangers. Therefore, the development of new materials that have both good hydrophilicity and antibacterial and mold-inhibiting properties has become an urgent problem to be solved in related industries.

Based on this, the present disclosure provides a coating material that can achieve relatively good antibacterial and mold-inhibiting effects and excellent hydrophilicity, a heat exchanger and a thermal management system. The technical solutions of the embodiments of the present disclosure can improve the antibacterial and mold-inhibiting properties and hydrophilicity of the coating material or coating layers in the related art, and are of great significance to the application of antibacterial and mold-inhibiting products in thermal management systems. The description of the specific technical solutions is provided as follows.

The technical solutions of the embodiments of the present disclosure provide a heat exchanger, the heat exchanger includes a metal base, and the metal base has a fluid channel for circulating a heat exchange medium;

the heat exchanger further includes a coating layer covering at least part of a surface of the metal base of the heat exchanger; the coating layer includes sol particles and an antibacterial material, the sol particles include silica, and the antibacterial material includes a rare earth element oxide.

In some embodiments, at least part of the silica is hydrophilically modified silica having a particle size in a nanoscale.

In some embodiments, the sol particles further include titanium dioxide, and the content of the silica is greater than that of the titanium dioxide. That is, the sol of the present disclosure is a mixed hydrophilic sol including a hydrophilically modified silica sol and a titanium dioxide sol.

In some embodiments, an outer surface of the metal base has an uneven rough surface, and the roughness of the rough surface is defined as Ra, and Ra satisfies 0.5 μm≤Ra≤10 μm. Exemplarily, the roughness of the rough surface is 0.5 μm, 1 μm, 2 μm, 3 μm, 4 μm, 5 μm, 6 μm, 7 μm, 8 μm, 9 μm, 10 μm and any value in a range formed by any two of these point values. It can be understood that controlling the roughness of the outer surface of the metal base within the above range is beneficial to the adhesion of the coating layer.

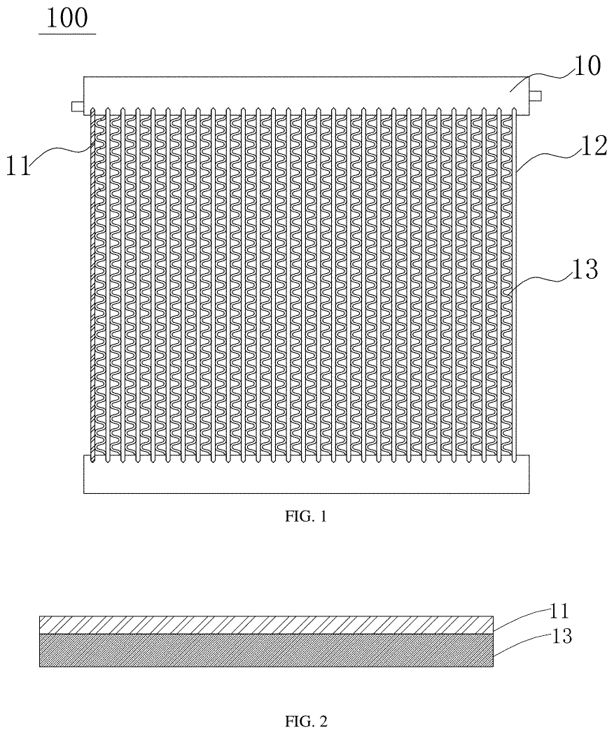

In some embodiments, the metal base includes at least one of a header 10, a heat exchange tube 12 and a fin 13. Exemplarily, as shown in FIG. 1, the main structure of the heat exchanger 100 includes two headers 10, a plurality of heat exchange tubes 12, and at least one fin 13, the heat exchange tube 12 is fixed to the header 10, an inner cavity of the heat exchange tube 12 is in communication with an inner cavity of the header 10, and the fin 13 is retained between two adjacent heat exchange tubes 12. The heat exchanger 100 is configured as a micro-channel heat exchanger. The micro-channel heat exchanger includes the heat exchange tube 12 and the fin 13, and at least part of a surface of the heat exchange tube 12 and/or a surface of the fin 13 has a coating layer 11 formed by applying and curing the above-mentioned coating material. In FIG. 1, the coating layer 11 is illustrated with reference to a shaded part on the surface of the leftmost heat exchange tube 12. Certainly, in other embodiments, the surfaces of other heat exchange tubes 12, fins 13, and headers 10 may be coated with the coating layer 11. For example, as shown in FIG. 2, the surfaces of the fins 13 are coated with the coating layer 11.

As shown in FIG. 1, the heat exchange tube 12 is connected between the two headers 10, the width of the heat exchange tube 12 is greater than the thickness of the heat exchange tube 12, and a plurality of heat exchange channels extending along a length direction of the heat exchange tube 12 are formed inside the heat exchange tube 12. Therefore, the heat exchange tube 12 may be configured as a micro-channel flat tube or an elliptical tube.

The plurality of heat exchange tubes 12 are arranged along an axial direction of the header 10. One end of the heat exchange tube 12 in the length direction is connected to one of the two headers 10, and the other end of the heat exchange tube 12 in the length direction is connected to the other of the two headers 10.

The fin 13 is corrugated along the length direction of the heat exchange tube 12. The fin 13 includes several crests and several troughs, and the crests and troughs of the fin 13 are respectively connected to two adjacent heat exchange tubes. In some embodiments, a window structure may be provided in part of the area of the fin 13 to form a louvered fin to further enhance heat exchange.

In some embodiments, the micro-channel heat exchanger is configured as an all-aluminum micro-channel heat exchanger. Structures and connection relationships of various components of the micro-channel heat exchanger a are conventional knowledge in the art and will not be repeated here.

The above-mentioned heat exchanger with the coating layer 11 may be applied to a thermal management system, such as an air-conditioning system, so that the air-conditioning system using the heat exchanger can reach the industry standard of antibacterial and mold-inhibiting properties, and has a remarkable effect, and also has good self-cleaning and hydrophilic effects, which is beneficial to the discharge of condensed water.

In some embodiments of the present disclosure, a coating material used to the surface of a heat exchanger to form a coating layer is provided, the coating material includes sol particles and an antibacterial material. The sol particles include silica, and the antibacterial material includes a rare earth element oxide. According to the present disclosure, a sol-gel method is adopted to prepare a hydrophilic material, so as to obtain an antibacterial agent that includes a silica sol with a small dosage of a rare earth element oxide added therein By combining a sol-gel silane system with a rare earth nano-oxide, a coating material with excellent antibacterial and mold-inhibiting effect and hydrophilicity can be obtained. By using the coating material for surface treatment of the heat exchanger, the heat exchanger not only has excellent self-cleaning and hydrophilic effect, but also achieves the antibacterial and mold-inhibiting effects, which can effectively reduce the cost. Therefore, the coating material is of great significance for the application of antibacterial and mold-inhibiting products in air conditioners.

In some embodiments, the coating material comprises the following components: 98-99.5 parts by mass of a sol and 0.5-2 parts by mass of an antibacterial material.

Unless otherwise specified, the percentages, ratios or parts involved herein are based on mass. “Part by mass” used here refers to a basic measurement unit of the mass ratio relationship of multiple components, and 1 part may represent any unit mass, for example, 1 part may be represented as 1 g, 1.68 g, 5 g, or the like.

According to the embodiments of the present disclosure, the coating material includes sol particles, and a dosage (in parts by mass) of the sol particles is 98 to 99.5 parts by mass, and for typical but non-limiting example, may be 98 parts by mass, 98.2 parts by mass, 98.5 parts by mass, 98.8 parts by mass, 99 parts by mass, 99.2 parts by mass, 99.4 parts by mass, 99.5 parts by mass, and any value in a range formed by any two of these point values.

According to the embodiments of the present disclosure, the coating material includes the antibacterial material, and a dosage (in parts by mass) of the antibacterial material is 0.5 to 2 parts by mass, and for typical but non-limiting example, may be 0.5 part by mass, 0.6 part by mass, 0.8 part by mass, 1 part by mass, 1.2 parts by mass, 1.5 parts by mass, 1.6 parts by mass, 1.8 parts by mass, 2 parts by mass, and any value in a range formed by any two of these point values.

In some embodiments, at least part of the silica is hydrophilically modified silica having a particle size in a nanoscale.

In some embodiments, the sol particles further include titanium dioxide, and the content of the silica is greater than the content of the titanium dioxide.

When the sol particles include titanium dioxide, that is, the sol of the present disclosure is the mixed hydrophilic sol including the hydrophilically modified silica sol and the titanium dioxide sol. The above-mentioned coating material is mainly made of appropriate dosages of a suitable mixed hydrophilic sol and antibacterial agent, wherein the mixed hydrophilic sol has excellent hydrophilicity, and the antibacterial agent has broad-spectrum antibacterial properties, high safety and good stability. The above-mentioned raw materials in dosage within the above-mentioned ranges is determined by comprehensively considering the contribution of each raw material to performance indicators of the coating material, such as hydrophilicity, antibacterial property, and synergy of the entire system. By synergistic cooperation of the above-mentioned specific contents of the antibacterial agent and the mixed hydrophilic sol, various properties are balanced, so that the prepared coating material has good hydrophilicity, achieves the antibacterial and mold-inhibiting effects, and moreover, reaches the performance indicators with reduced costs. In some embodiments, the mixed hydrophilic sol includes the following components: 90 to 92 parts by mass of the hydrophilically modified silica sol, and 4 to 6 parts by mass of the titanium dioxide sol. Since the mixed hydrophilic sol includes silica and titanium dioxide, the coating layer can form a structure with relatively stable physical and chemical properties, so that the coating layer is stable and dense, and the hydrophilicity of the coating layer can be further improved to achieve good hydrophilicity and durability.

The content of the hydrophilically modified silica sol is 90 to 92 parts by mass, and for typical but non-limiting example, may be 90 parts by mass, 90.5 parts by mass, 90.8 parts by mass, 91 parts by mass, 91.2 parts by mass, 91.5 parts by mass, 92 parts by mass and any value in a range formed by any two of these point values. When the silica particles are prepared by a sol method, there will be a large number of Si—OH groups on the surface of the silica particles, and due to a reactive group hydroxyl (—OH), a coating layer with excellent hydrophilicity can be obtained through mutual reaction between the particles. In addition, the hydrophilicity of the coating layer can be improved by making the content of silica within this range.

The content of the titanium dioxide sol is 4 to 6 parts by mass, and for typical but non-limiting example, may be 4 parts by mass, 4.5 parts by mass, 4.8 parts by mass, 5 parts by mass, 5.2 parts by mass, 5.5 parts by mass, 5.8 parts by mass, 6 parts by mass, and any value in a range formed by any two of these point values. Titanium dioxide particles have amphoteric particles as well as photocatalytic properties, and are photoinduced superhydrophilic. When the titanium dioxide particles are prepared by the sol method, there will be a large number of Ti—OH groups on the surface of the titanium dioxide particles, and due to the reactive group hydroxyl (—OH), a coating layer with excellent hydrophilicity can be obtained through mutual reaction between the particles. In addition, by making the contents of the hydrophilically modified silica sol and the titanium dioxide sol within these ranges, the advantages of silica and titanium dioxide can be fully utilized, and the synergistic effect of silica and titanium dioxide can be enhanced, which is beneficial to further improving the hydrophilicity of the coating layer.

In some embodiments of the present disclosure, a preparation method of a coating material is provided, the preparation method includes the following step: mixing 98 to 99.5 parts by mass of the mixed hydrophilic sol and 0.5 to 5 parts by mass of an antibacterial material thoroughly, to obtain the coating material; wherein the mixed hydrophilic sol includes the hydrophilically modified silica sol and the titanium dioxide sol, the antibacterial material includes an rare earth element oxide. In some embodiments, mixed hydrophilic sol includes the following components: 90 to 92 parts by mass of the hydrophilically modified silica sol and 4 to 6 parts by mass of the titanium dioxide sol.

According to the preparation method, the coating material is prepared by thoroughly mixing appropriate contents of the mixed hydrophilic sol and the antibacterial material. The preparation process is simple, easy to control, highly feasible, and has little environmental pollution, and thus the preparation method is suitable for industrial mass production. According to the preparation method of a coating material, the rare earth element oxide-containing antibacterial material is used in combination with the mixed hydrophilic sol, which can give full play to the advantages of each component, so as to enable the coating layer to have excellent self-cleaning and hydrophilic effects and antibacterial and mold-inhibiting effects. The coating material having excellent properties, antibacterial and mold-inhibiting effects and hydrophilicity can be prepared by the preparation method, moreover, the performance indicators can be meet while reducing costs.

It should be understood that the preparation method of the coating material and the aforementioned coating material are based on the same application concept. For composition and proportion of the raw materials of the coating material and other related features, the description of aforementioned section of the coating material may be referenced, which will not be repeated here.

The coating material according to the embodiments of the present disclosure is suitable to be applied to the field of heat exchanger, and can provide a coating with excellent hydrophilicity and antibacterial and mold-inhibiting properties on the surface of the heat exchanger.

In some embodiments, the preparation method of the coating material includes: adding 0.5 to 5 parts by mass of the antibacterial agent to 98 to 99.5 parts by mass of the mixed hydrophilic sol, and mechanically mixing the mixture thoroughly for 20 to 30 min to obtain the coating material. The time of mechanical mixing is, for example, 20 min, 22 min, 25 min, 28 min, 30 min, or the like.

The method of mixing the above-mentioned mixed hydrophilic sol with the antibacterial agent includes, but is not limited to, mechanical mixing. In other embodiments, various common mixing methods well known in the art may also be used, such as ultrasonic mixing, a combination of mechanical mixing and ultrasonic mixing, or the like, the embodiments of the present disclosure do not make any special limitations on this.

According to the embodiments of the present disclosure, the sources of the antibacterial material and the mixed hydrophilic sol are not particularly limited, and the antibacterial material and the mixed hydrophilic sol may be home-made or commercial products. For example, in the preparation process of the coating material, the preparation of the antibacterial agent may be followed by the preparation of the mixed hydrophilic sol; alternatively, the preparation of the mixed hydrophilic sol may be followed by the preparation of the antibacterial agent; alternatively, the preparation of the antibacterial agent and the preparation of the mixed hydrophilic sol may be performed at the same time. The preparation sequence of the antibacterial agent and the mixed hydrophilic sol is not limited in the embodiments of the present disclosure. Alternatively, in other embodiments, at least one of the antimicrobial agent and the mixed hydrophilic sol is commercially available product.

The preparation of the mixed hydrophilic sol will be described in detail below.

In some embodiments, the mixed hydrophilic sol includes the following raw materials: 90 to 92 parts by mass of the hydrophilically modified silica sol, 4 to 6 parts by mass of the titanium dioxide sol, and 3 to 5 parts by mass of a pH adjuster.

In some embodiments, the preparation method of the mixed hydrophilic sol includes:

mixing 90 to 92 parts by mass of the hydrophilically modified silica sol and 4 to 6 parts by mass of the titanium dioxide sol, to obtain a mixed solution, and adding 3 to 5 parts by mass of the pH adjuster to adjust the pH of the mixed solution to 2.5 to 3.5, and then stirring the mixed solution at 45° C. to 55° C. for 3.5 h to 5 h for a reaction, to obtain the mixed hydrophilic sol.

According to the embodiments of the present disclosure, there are no limitations on the sources and specific types of preparation raw materials of the above-mentioned mixed hydrophilic sol, and those skilled in the art may choose the raw materials flexibly according to actual needs, provided that the objective of the present disclosure is not limited. For example, various raw materials well-known to those skilled in the art may be used, commercial products thereof may be used, or home-made products thereof may be used. In some embodiments of the present disclosure, part of the above-mentioned 90 to 92 parts by mass of the hydrophilically modified silica sol are commercially available products, and the other part is prepared according to the preparation method of the embodiments of the present disclosure, which is conducive to further improving the hydrophilicity. Certainly, in some embodiments of the present disclosure, the above-mentioned 90 to 92 parts by mass of the hydrophilically modified silica sol may completely be commercially available product. Alternatively, in some other embodiments of the present disclosure, the above-mentioned 90 to 92 parts by mass of the hydrophilically modified silica sol completely be prepared according to the preparation method of the embodiments of the present disclosure.

In some embodiments, among the above-mentioned 90 to 92 parts by mass of the hydrophilically modified silica sol, 34 to 36 parts by mass of the hydrophilically modified silica sol are prepared according to the preparation method of the embodiments of the present disclosure, and the rest of the hydrophilically modified silica sol are all commercially available product.

According to the embodiments of the present disclosure, there are no limitations on the sources and specific types of the above-mentioned titanium dioxide sol and pH adjuster and other raw materials, and those skilled in the art may choose flexibly according to actual needs, provided that the objective of the present disclosure is not limited. For example, various raw materials well-known to those skilled in the art may be used, commercial products thereof may be used, or the raw materials may be home-made according to preparation methods well-known to those skilled in the art.

The above-mentioned mixed hydrophilic sol is mainly prepared from appropriate dosages of a suitable hydrophilically modified silica sol, titanium dioxide sol and pH adjuster, which has excellent hydrophilicity. The hydrophilically modified silica sol and the titanium dioxide sol are hydrophilic materials having certain reactive groups or hydrophilic groups, such as hydroxyl (—OH), and a dense coating material can be obtained through the mutual reaction between particles. The coating material has stable chemical properties and can give full play to its own weather resistance, hydrophilicity and other basic properties.

In order to optimize the dosage of each component in the mixed hydrophilic sol and improve the synergistic effect of the components, in some embodiments, the hydrophilic modified mixed sol includes the following raw materials: 91 parts by mass of the hydrophilically modified silica sol, 5 parts by mass of the titanium dioxide sol, and 4 parts by mass of the pH adjuster. Further, in some embodiments, the mixed hydrophilic sol includes the following raw materials: 35 parts by mass of a home-made hydrophilically modified silica sol, 56 parts by mass of a commercially available silica sol, 5 parts by mass of the titanium dioxide sol, and 4 parts by mass of the pH adjuster. The commercially available silica sol may be a hydrophilically modified silica sol, or the commercially available silica sol includes dispersed silica particles. The commercially available silica sol may be mixed with the home-made hydrophilically modified silica sol to obtain a mixed hydrophilically modified silica sol.

In some embodiments, the above-mentioned preparation method of the home-made hydrophilically modified silica sol includes the following step: mixing 50 to 56 parts by mass of a solvent, 0.5 to 1.5 parts by mass of a surfactant, 36 to 40 parts by mass of a silane precursor, 1 to 2 parts by mass of an acid, and 3 to 8 parts by mass of water together to have a reaction at 45° C. to 55° C. for 22 h to 24 h, to obtain the hydrophilically modified silica sol. Further, in some embodiments, the preparation method of the above-mentioned home-made hydrophilically modified silica sol includes the following steps: mixing 50 to 56 parts by mass of the solvent with 0.5 to 1.5 parts by mass of the surfactant, dispersing by ultrasonic for 10 min to 20 min, and then adding 36 to 40 parts by mass of the silane precursor to the system, mechanically stirring the system at 200 to 300 rpm for 20 min to 40 min in a water bath at 45° C. to 55° C., and then dropwise adding 3 to 8 parts by mass of water and 1 to 2 parts by mass of the acid to the system within about 10 min to having a reaction at 45° C. to 55° C. for 22 h to 24 h, to obtain the hydrophilically modified silica sol. The time of above-mentioned dispersing by ultrasonic may be, for example, 10 min, 12 min, 15 min, 18 min, 20 min, or the like; the temperature of above-mentioned mechanical stirring may be, for example, 45° C., 48° C., 50° C., 52° C., 55° C., or the like, the time of mechanical stirring may be, for example, 20 min, 25 min, 30 min, 35 min, 40 min, or the like; the stirring speed is, for example, 200 rpm, 250 rpm, 300 rpm, or the like. The temperature of the above-mentioned reaction may be, for example, 45° C., 48° C., 50° C., 52° C., 55° C., or the like, and the time of the reaction time may be, for example, 22 h, 23 h, 24 h, or the like.

In other embodiments, the preparation method of the above-mentioned home-made hydrophilically modified silica sol includes the following steps:

mixing 36 to 40 parts by mass of the silane precursor and 50 to 56 parts by mass of the solvent thoroughly at 45° C. to 55° C., and then adding 2 to 4 parts by mass of water and 0.5 to 1.5 parts by mass of the surfactant, and mixing the mixed solution thoroughly, and then adding 1 to 2 parts by mass of the acid and 2 to 4 parts by mass of water to the system to have a reaction for 22 h to 24 h to obtain the hydrophilically modified silica sol. The temperature is, for example, 45° C., 46° C., 48° C., 50° C., 52° C., 54° C., 55° C., or the like; the time of the reaction is, for example, 22 h, 22.5 h, 23 h, 23.5 h, 24 h, or the like.

It should be understood that, in the above-mentioned preparation method of the home-made hydrophilically modified silica sol, the addition sequence or mixing method of the preparation raw materials may be adjusted according to the above two methods. For example, in some cases, the solvent and surfactant may be mixed first, and then the silane precursor is added, and the mixed solution is mixed thoroughly, and water and the acid is added. Alternatively, in some other cases, the silane precursor and the solvent may be mixed first, and then part of the water and surfactant is added, the mixed solution is mixed thoroughly, and finally the remaining water and acid is added. In practical applications, the specific preparation method of the hydrophilically modified silica sol may be flexibly selected by those skilled in the art according to actual needs. In addition, the specific methods or specific conditions of the above-mentioned mixing or reaction, such as ultrasonic stirring, mechanical stirring, or the like, may also be adjusted according to the actual situation.

In the above two preparation methods of the hydrophilically modified silica sol, the content of the silane precursor may be, for example, 36 parts by mass, 37 parts by mass, 38 parts by mass, 39 parts by mass, 40 parts by mass, or the like; the content of the solvent may be, for example, 50 parts by mass, 51 parts by mass, 52 parts by mass, 53 parts by mass, 54 parts by mass, 55 parts by mass, 56 parts by mass, or the like; the content of water may be, for example, 1 part, 1.5 parts by mass, 2 parts by mass, 2.5 parts by mass, 3 parts by mass, 3.5 parts by mass, 4 parts by mass, 5 parts by mass, 6 parts by mass, 8 parts by mass, or the like; the content of the surfactant may be, for example, 0.5 parts by mass, 0.8 parts by mass, 1 part by mass, 1.2 parts by mass, 1.5 parts by mass, or the like; the content of the acid is, for example, 1 part, 1.2 parts by mass, 1.5 parts by mass, 1.6 parts by mass, 1.8 parts by mass, 2 parts by mass, or the like.

The specific type of the above-mentioned silane precursor may be varied, provided that the requirements, such as, requirements for the hydrophilicity of the mixed hydrophilic sol, are met. Specifically, in some embodiments, the silane precursor includes 30 to 32 parts by mass of γ-glycidyl ether oxypropyltrimethoxysilane (KH-560) and 6 to 8 parts by mass of ethyl orthosilicate. Exemplarily, the content of KH-560 may be, for example, 30 parts by mass, 31 parts by mass, 32 parts by mass, or the like; the content of ethyl orthosilicate may be, for example, 6 parts by mass, 7 parts by mass, 8 parts by mass, or the like.

In addition, in other embodiments, the silane precursor is not limited to that listed above, and other types of silane precursors may also be used, provided that the requirements, such as, requirements for the hydrophilicity of the mixed hydrophilic sol, are met. For example, the silane precursor may also be hexamethyldisilazane, chlorosilane, or the like, which will not be described in detail here.

Using a mixture of KH-560 and ethyl orthosilicate of certain content as the silane precursor is more helpful to obtain the hydrophilically modified silica sol with excellent hydrophilicity, and is helpful to obtain a sol with good hydrophilically and durability.

The specific types of the solvent, the surfactant, and the acid may be varied, provided that the requirements, such as, requirements for the hydrophilicity of the mixed hydrophilic sol, are met. Specifically, in some embodiments, the solvent includes alcohol solvents. Further, the alcohol solvents include alcohol solvents having 1 to 10 carbon atoms, preferably alcohol solvents having 1 to 8 carbon atoms, and more preferably alcohol solvents having 1 to 4 carbon atoms. Further, in some embodiments, the solvent is any one of methanol, ethanol and isopropanol, or a mixture of any two or more of methanol, ethanol and isopropanol in any ratio. Thus, the sources are wide, easily available, and low in cost.

In some embodiments, the surfactant includes, but is not limited to, at least one of sodium dodecyl sulfate, sodium dodecyl sulfonate, sodium dodecyl benzene sulfonate, and cetylbenzenesulfonic acid. Further, in some embodiments, the surfactant is sodium dodecyl sulfate. Thus, the surfactant has the advantages of low cost, wide source, and good use effect.

In some embodiments, the acid includes, but is not limited to, at least one of formic acid and acetic acid. Further, in some embodiments, the acid is formic acid.

In some specific embodiments, the preparation method of the above-mentioned home-made hydrophilically modified silica sol includes: mixing 31 parts by mass of KH-560, 7 parts by mass of ethyl orthosilicate and 54 parts by mass of anhydrous ethanol thoroughly by mechanically stirring in a water bath at 45° C. to 55° C., to obtain a mixture; and then mixing 3 parts by mass of water and 1 part of sodium dodecyl sulfate thoroughly to obtain a solution, and adding the solution to the mixture; and then dropwise adding 1 part of formic acid and 3 parts by mass of water to the mixture, mixing thoroughly to have a reaction for about 24 h while keeping the reaction conditions unchanged, to obtain the hydrophilically modified silica sol. Alternatively, in some other specific embodiments, the preparation method of the above-mentioned home-made hydrophilically modified silica sol includes: mixing 54 parts by mass of absolute ethanol and 1 part of sodium dodecyl sulfate, dispersing by ultrasonic dispersion for 10 min; then, adding 31 parts by mass of KH-560 and 7 parts by mass of ethyl orthosilicate, and mechanically stirring at 250 rpm for 30 min in a 50° C. water bath, and then dropwise adding 6 parts by mass of water and 1 part of formic acid to the system within 10 min to have a reaction in a 50° C. water bath for about 24 h, to obtain the hydrophilically modified silica sol.

The equations or reaction mechanism involved in the above preparation of the hydrophilically modified silica sol may be as follows:

1) Hydrolytic condensation of ethyl orthosilicate: Si(OCH₂CH₃)₄+2H₂O→SiO₂+4C₂H₅OH;

2) Hydrolysis of KH560: R—Si(OCH₃)₃+3H₂O→R—Si(OH)₃+CH₃OH;

Polycondensation of KH560: R—Si(OH)₃+R—Si(OH)₃→R—Si(OH)₂—O—Si(OH)₂—R+H₂O,

R—Si(OH)₃+R—Si(OCH₃)₃→R—Si(OH)₂—O—Si(OH)₂—R+CH₃OH;

where R represents a long-chain group —(CH₂)₃—O—CH₂—CH—OCH₂, and KH560 has the following the structural formula (I):

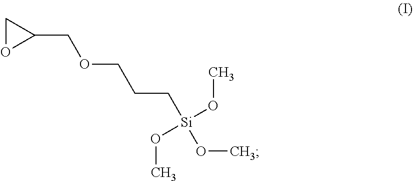

3) Condensation of KH560 and silanol: R—Si(OH)₃+Si(OH)₄→R—Si(OH)₂—O—Si(OH)₃+H₂O.

The hydrophilically modified silica sol prepared according to the embodiments of the present disclosure includes a large number of hydroxyl (—OH) hydrophilic groups, so that the sol exhibits hydrophilicity. Besides, the dehydration condensation between hydroxyl groups forms a spatial network structure. As a result, dispersed nanoparticles, such as silica and titanium dioxide, further added to the mixed hydrophilic sol can be filled into the spatial network structure, so as to form a stable sol system, i.e., the mixed hydrophilic sol. The mixed hydrophilic sol can be bonded to —OH on the metal base, which form a covalent bond by dehydration condensation. After the formation of a film, the metal base can be protected, thereby achieving the effects of hydrophilicity and corrosion resistance.

The pH adjuster includes organic acid or inorganic acid, provided that the requirements, such as, requirements for the hydrophilicity of the mixed hydrophilic sol, are met. Specifically, in some embodiments, the pH adjuster is formic acid.

In some specific embodiments, the preparation method of the mixed hydrophilic sol includes:

preparing the home-made hydrophilically modified silica sol according to the above-described preparation method; mixing 35 parts by mass of the prepared home-made hydrophilically modified silica sol, 56 parts by mass of the commercially available hydrophilically modified silica sol and 5 parts by mass of the titanium dioxide sol, and adjusting the pH value of the system to about 3.0 by using 4 parts by mass of the pH value adjuster, i.e., formic acid, and then stirring the system for about 4 h to 5 h in a water bath at 45° C. to 55° C. to have a reaction, to obtain the mixed hydrophilic sol. The obtained mixed hydrophilic sol is a mixed sol with an enhanced hydrophilic effect.

In the mixed hydrophilic sol prepared by the above method, the advantages of each component are brought into full play by mixing the above-mentioned home-made hydrophilically modified silica sol, commercially available silica sol and titanium dioxide sol. The mixed sol with good hydrophilicity and durability which can further improve the hydrophilicity of the coating layer can be obtained. The silica particles have a large amount of Si—OH groups on the surface, and thus, have excellent hydrophilicity. The titanium dioxide particles have photoinduced superhydrophilicity: under illumination, electrons in the valence band of TiO₂ are excited to a conduction band, electrons and holes migrate to the surface of TiO₂ to generate electron-hole pairs on the surface. Positive trivalent titanium ions and oxygen vacancies are formed by a reaction between the electrons and Ti⁴⁺, and a reaction between the holes and surface bridge oxygen ions, respectively. At this time, water in the air is dissociated and adsorbed in the oxygen vacancies, and becomes chemisorbed water (surface hydroxyl groups). The chemisorbed water can further adsorb the water in the air to form a physical adsorption layer, that is, to form a highly hydrophilic microdomain around the trivalent titanium defect.

In addition, the above-mentioned home-made hydrophilically modified silica sol is prepared by a hydrolysis reaction of ethyl orthosilicate and KH560. The home-made hydrophilically modified silica contains nano-scale silica particles, and has good dispersibility. The particles in commercially available silica sol may be in micron or submicron scales. By the combination of silica particles with different particle sizes, the surface morphology of the coating layer after coating is improved, its surface energy is increased, and the hydrophilicity of the coating layer is improved.

In the above-described coating material, the antibacterial material includes the rare earth element oxide, wherein the rare earth elements may be various types of rare earth elements, such as lanthanide rare earth elements, and the lanthanide rare earth elements may include at least one of lanthanum, cerium, praseodymium, neodymium, promethium, samarium and europium.

The embodiments of the present disclosure do not limit the specific type or source of the above-mentioned antibacterial material, and those skilled in the art may flexibly select the antibacterial material according to actual needs, provided rare earth element oxides is contained, and no limitations is generated to the objective of the present disclosure. For example, both commercially available products and home-made products may be used.

An antibacterial material containing a rare earth element oxide is used. The rare earth element oxide is nano-scale particles with high activity. On the one hand, the rare earth element oxide may enable oxygen molecules to generate superoxide ions O₂— and OH, and on the other hand, the high-valent rare-earth metal ions in the rare-earth metal oxide have the lowest redox potential (1.7 eV) during high-to-low valence state conversion, and thus, can easily provide oxygen free radicals to combine with water to form active H₂O₂, which can react with the organic matter in the microorganisms while in contact with microorganisms, thereby killing microorganisms in a short time, so as to play an antibacterial and bactericidal effect. In addition, the rare earth ions can cause distortion in the local lattice potential field of metal oxide nanoparticles, improve the photocatalytic activity of the nano metal oxide, and extend the catalytic effective range to the visible light region, so as to achieve the catalytic antibacterial effect in the visible light region.

The rare earth element oxide in the above-mentioned antibacterial material containing the rare earth element oxide is a nanomaterial with photocatalytic activity, which generate energy to makes the film surface adsorb water molecules and oxygen molecules to form hydroxyl radicals and active oxygen after absorbing light. The hydroxyl radicals and active oxygen have very strong oxidizing ability, and can degrade the organic matter attached to the surface into carbon dioxide and water, so that the surface of the heat exchanger has a self-cleaning function and is easy to clean. Therefore, the antibacterial material can exert both antibacterial and self-cleaning properties.

An embodiment of the present disclosure further provides a method for preparing the above-described heat exchanger, which includes the following steps:

applying the composite material to at least part of the surface of the heat exchange tube and/or at least part of the surface of the fin, and then cured to obtain the heat exchanger.

Further, during the preparation process of the heat exchanger, the surface of the heat exchange tube and/or the surface of the fin are pretreated first, and then the composite material is applied to pretreated surface of the heat exchange tube and/or pretreated surface of the fin, and then curing, to obtain a coated heat exchanger.

Specifically, in some embodiments, the surface of the heat exchange tube and/or the surface of the fin of the heat exchanger is pretreated, where the pretreating step of the heat exchanger specifically includes: performing a sandblasting of 100 to 200 meshes on the surface of the heat exchange tube and/or the surface of the fin, and then cleaning the surface of the heat exchange tube and/or the surface fin with alcohol or acid, and then airing or drying the surface at a temperature of 35° C. to 50° C.

Further, during the pretreating process, the number of blasting meshes in some embodiments is 120 to180 meshes, for example, the number of blasting meshes is 150 meshes. The cleaning method used may be, for example, ultrasonic cleaning with anhydrous ethanol or acid etching.

In some embodiments of the present disclosure, the method for applying the composite material to the heat exchanger includes, but is not limited to, at least one of dip-coating, spray coating, brushing, curtain coating or roller coating. Considering the convenience of implementation, the composite material provided by the embodiments of the present disclosure may be applied to the pretreated surface of the heat exchange tube and/or the pretreated surface of the fin by spraying or dipping, where the time of dipping is 2 to 5 min, and further, may be 2 to 3 min; and the dipping is carried out for 2 to 5 times, and further, may be 2 or 3 times.

In some embodiments, the composite material is cured after being applied to the pretreated surface of the heat exchange tube and/or the pretreated surface of the fin and then cured, with the curing temperature is 180° C. to 220° C., and further, may be 190° C. to 210° C., and further, may be 200° C.; and the curing time is 0.5 h to 2 h, and further, may be 0.8 h to 1.5 h, and further, may be 1 h.

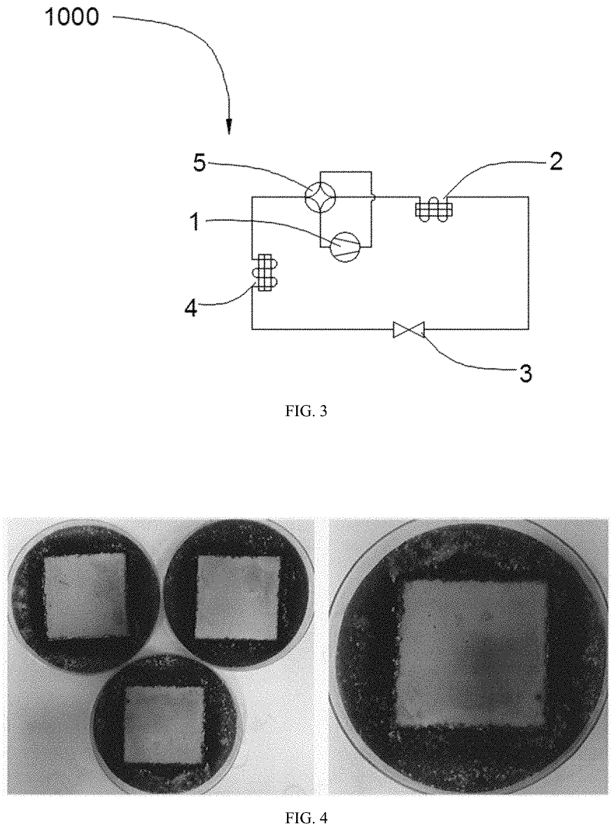

The embodiments of the present disclosure further provide a thermal management system, where the above-mentioned heat exchanger is included. Specifically, as shown in FIG. 3, it is a thermal management system 1000 shown in an exemplary embodiment of the present disclosure. The thermal management system 1000 includes at least a compressor 1, a first heat exchanger 2, a throttling device 3, a second heat exchanger 4, and a reversing device 5. The compressor 1 of the thermal management system 1000 may be configured as a horizontal compressor or a vertical compressor. The throttling device 3 may be configured as an expansion valve, or the throttling device 3 is other components that have the effect of reducing the pressure and regulating the flow of a refrigerant. The present disclosure does not specifically limit the type of the throttling device. The throttling device may be selected according to the actual application environment, which will not be repeated here. It should be noted that, in some systems, the reversing device 5 may not be provided. The heat exchangers in the foregoing embodiments of the present disclosure may be used in the thermal management system 1000 as the first heat exchanger 2 and/or the second heat exchanger 4. In the thermal management system 1000, the refrigerant is compressed by the compressor 1, the temperature of the refrigerant increases after being compressed, and then the compressed refrigerant enters the first heat exchanger 2 to transfer heat to outside through the heat exchange between the first heat exchanger 2 and the outside; and then the refrigerant turns into a liquid or gas-liquid two-phase state after passing through the throttling device 3, where the temperature of the refrigerant decreases, and then the refrigerant with a relatively low temperature flows to the second heat exchanger 4, and after the second heat exchanger 4 exchanges heat with the outside, the refrigerant with a lower temperature enters the compressor 1 again, to achieve the circulation of the refrigerant.

In other embodiments of the present disclosure, the coating material of the present disclosure may also be used to products other than heat exchangers, such as filter devices of air conditioning systems. Certainly, the coating material of the embodiments of the present disclosure may also be used to other products that require improved hydrophilicity and/or antibacterial and mold-inhibiting properties.

In order to fully illustrate the relevant properties of the coating material of the present disclosure and facilitate the understanding of the present disclosure, multiple tests have been carried out for verifications in the present disclosure. The present disclosure will be further explained below in conjunction with specific examples and comparative examples. Those skilled in the art will understand that the descriptions in the present disclosure are only part of examples, and any other suitable specific examples are within the scope of the present disclosure.

### EXAMPLE 1

### 1. Preparation of the Coating Material

99 parts by mass of a mixed hydrophilic sol and 1 part of an antibacterial agent were mixed thoroughly to obtain a coating material, where the mixed hydrophilic sol includes 91 parts by mass of the hydrophilically modified silica sol and 5 parts by mass of the titanium dioxide sol, and the antibacterial agent includes a rare earth element oxide.

### 2. Treatment of the Heat Exchanger

The surfaces of the heat exchange tube and/or the surface of the fin of the heat exchanger were pretreated. Specifically, the surfaces of the heat exchange tube and/or the surface of the fin of the heat exchanger were sandblasted with 150-mesh sand, and then cleaned with anhydrous ethanol, and then air-dried.

The coating material obtained in step 1 was applied to the pretreated surface of the heat exchange tube and/or the pretreated surface of the fin by dip coating or spray coating, and then was cured at 200° C. for 1 h, to obtain a heat exchanger with a coating.

### EXAMPLES 2 TO 4

The coating material and the heat exchanger were prepared in the same manner as that in Example 1, except for the ratio of the mixed hydrophilic sol to the antibacterial agent.

In Example 2, 98 parts by mass of the mixed hydrophilic sol and 2 parts by mass of the antibacterial agent were mixed thoroughly.

In Example 3, 99.5 parts by mass of the mixed hydrophilic sol and 0.5 part of the antibacterial agent were mixed thoroughly.

In Example 4, 98.5 parts by mass of the mixed hydrophilic sol and 1.5 parts by mass of the antibacterial agent were mixed thoroughly.

The rest are the same as that in Example 1.

### EXAMPLES 5 TO 10

The coating material and the heat exchanger were prepared in the same manner as that in Example 1, except for the preparation of the mixed hydrophilic sol.

In Example 5, the mixed hydrophilic sol was prepared as follows: (a) 54 parts by mass of absolute ethanol and 1 part of sodium dodecyl sulfate were mixed, and then subjected to ultrasonic dispersion for 10 min; and then, 31 parts by mass of KH-560 and 7 parts by mass of ethyl orthosilicate were added, and the system was mechanically stirred at 250 rpm for 30 min in a 50° C. water bath, and then 6 parts by mass of water and 1 part of formic acid were added dropwise to the system within 10 min to have a reaction in a 50° C. water bath for about 24 h, and then the hydrophilically modified silica sol was obtained.

(b) 35 parts by mass of the hydrophilically modified silica sol obtained in step (a), 56 parts by mass of commercially available silica sol and 5 parts by mass of titanium dioxide sol were mixed, and then 4 parts by mass of the pH regulator formic acid was added to adjust the pH of the system to about 3.0, and the system was then stirred for about 4 h in a water bath at about 50° C. to have a reaction, and the mixed hydrophilic sol was then obtained.

Example 6 is the same as Example 5 except that, in step (b), 33 parts by mass of the hydrophilically modified silica sol obtained in step (a), 57 parts by mass of commercially available silica sol, and 6 parts by mass of titanium dioxide sol were mixed. The rest is the same as that in Example 5.

Example 7 is the same as Example 5 except that, in step (b), 37 parts by mass of the hydrophilically modified silica sol obtained in step (a), 54.5 parts by mass of commercially available silica sol, and 4.5 parts by mass of titanium dioxide sol were mixed. The rest is the same as that in Example 5.

Example 8 is the same as Example 5 except that, in step (b), 91 parts by mass of the hydrophilically modified silica sol obtained in step (a) and 5 parts by mass of titanium dioxide sol were mixed. The rest is the same as that in Example 5.

Example 9 is the same as Example 5 except that, in step (a), 56 parts by mass of absolute ethanol and 0.5 part of sodium dodecyl sulfate were mixed and then subjected to ultrasonic dispersion for 10 min; and then, 30 parts by mass of KH-560 and 6 parts by mass of ethyl orthosilicate were added, and the system was mechanically stirred at 250 rpm for 30 min in a 50° C. water bath, and then 6.5 parts by mass of water and 1 part of formic acid were added dropwise to the system within 10 min to have a reaction in a 50° C. water bath for about 24 h, and then the hydrophilically modified silica sol was obtained.

Example 10 is the same as Example 5 except that, in step (a), 31 parts by mass of KH-560, 7 parts by mass of ethyl orthosilicate and 54 parts by mass of anhydrous ethanol were mechanically mixed and stirred thoroughly in a water bath at about 50° C. to obtain a mixed solution; and then 3 parts by mass of water and 1 part of sodium dodecyl sulfate were thoroughly mixed and then added to the mixed solution; and then 1 part of formic acid and 3 parts by mass of water were added dropwise to the mixed solution, and the mixed solution was then mixed thoroughly to have a reaction for about 24 h while keeping the reaction condition unchanged, and the hydrophilically modified silica sol was then obtained.

### COMPARATIVE EXAMPLE 1

Comparative Example 1 differs from Example 1 in that, according to Comparative Example 1, the surface of the heat exchange tube and/or the surface of the fin of the heat exchanger were sandblasted with 150-mesh sand, and then cleaned with anhydrous ethanol, and then air-dried. In addition, the surface of the heat exchanger of Comparative Example 1 is not provided with a coating layer formed by the coating material.

### Performance Test

In order to facilitate the property test, the test was carried out by means of applying the coating material to a 3003 aluminum plate or other types of aluminum plate. That is, an aluminum plate made of the same material as that of the heat exchangers of the above examples and comparative example was used, and the above-mentioned coating material was applied to the aluminum plate for testing. Correspondingly, the surface of the aluminum plate was also subjected to 150-mesh sandblasting treatment, washed with absolute ethanol, and then air-dried, so as to simulate real heat exchanger products.

Specifically, the coating materials in Examples 1 to 10 were respectively applied to the pretreated surface of the aluminum plate to obtain the coated aluminum plate test samples corresponding to Examples 1 to 10. Control Example 1 which is corresponding to Comparative Example 1 provided an aluminum plate that was pretreated but not coated. The test method is as follows.

### 1. Hydrophilicity Test (Contact Angle Test)

The test instrument used was a contact angle measuring instrument which measured the contact angle of a sample by an image profile analysis method based on the principle of optical imaging. The contact angle refers to an angle formed at a solid-liquid-gas three-phase junction on a solid surface when a liquid phase is sandwiched by two tangents of a gas-liquid interface and a solid-liquid interface after a liquid drop falls on a horizontal solid plane.

In the test, the contact angle measuring instrument and the computer connected to it were turned on, and testing software was enabled.

A sample was placed on a horizontal workbench, the amount of a droplet was adjusted by using a micro-injector (the volume of the droplet is generally about 1 μl). A droplet was formed on the needle. The knob was then turned to move the workbench up so that the surface of the sample came into contact with the droplet. The workbench was then moved down, and then the droplet was left on the sample.

The contact angle of this area is obtained by testing and data analysis through the testing software. The sample of each of Embodiments and Comparative Examples was tested at 5 different points and an average value was taken and recorded as the contact angle of the sample of the Example and of the Comparative Example.

The above contact angle test results show that the initial contact angles of the surfaces of samples from Examples 1 to 10 are all less than 10°, while the initial contact angle of the surface of the sample from Comparative Example 1 is 39.114°. Therefore, it shows that hydrophilicity had been increased by the coating material of the present disclosure. The coating material had excellent hydrophilicity, which was conducive to the discharge of condensed water, so that it is not easy to form a wet water environment on the surface of the sample.

### 2. Test on Antibacterial Rate and Mold-Inhibiting Property (Take Example 1 and Comparative Example 1 as Examples for Description)

### 2.1 Antibacterial Rate

(1) Test sample: the test sample was obtained by directly cutting from the heat exchanger, or the test sample was made from the same raw material as that of the heat exchanger, and processed via the same method as that of the heat exchanger. The size of the test sample was (50±2) mm×(50±2) mm, or the area to be tested should not be less than 1600 mm².

(2) Control sample: a standard sample with a size of (50±2) mm×(50±2) mm and a thickness of not more than 5 mm, by injection molding of sanitary high-density polyethylene (HDPE).

(3) Test principle: bacteria was quantitatively inoculated on the samples to be tested and the control samples, the bacteria were evenly contacted with the samples by the method of sticking a film, after (24±1) h of culture, the number of viable bacteria in the two groups of samples was measured, compared and calculated, and then the antibacterial rates of the samples were obtained.

(4) Test bacteria: Staphylococcus aureus AS 1.89, equivalent to ATCC 6538p; Escherichia coli AS 1.90.

For the specific detection method and basis of the antibacterial rate, reference can be made to “GB21551.2-2010 Special Requirements for Antibacterial Materials with Antibacterial, Sterilization and Purification Functions for Household and Similar Electrical Appliances” (Appendix A, Appendix C).

The test results of the antibacterial rate are shown in Table 1 below.

TABLE 1
The test results of the antibacterial rate of Example 1

| | | | The average | Average | |
|---|---|---|---|---|---|
| | | | number of | bacterial | |
| | | | bacteria | count | |
| | | | recovered of | of test | |
| Sample | Action | | blank control | samples | Antibacterial |
| No. | time | Test strain | samples (CFU) | (CFU) | rate (%) |
| Example 1 | 24 h | Escherichia coli | 9.0 × 10⁷ | <20 | >99.99 |
| | | Staphylococcus | 3.8 × 10⁸ | <20 | >99.99 |
| | | aureus | | | |

### 2.2 Mold-Inhibiting Property

(1) Test strains: Aspergillus niger AS 3.4463, Aspergillus terreus AS 3.3935, Paecilomyces variotii AS 3.4253, Penicillium funiformis AS3.3875, Chaetomium globulus AS 3.4254, and Aureobasidium pullulans AS 3.3984.

(2) Test conditions: time of 28 days; humidity of greater than 90% RH; temperature of 28° C.

(3) Evaluation criteria:

Mold grade: Grade 0: no growth, i.e., no visible growth under a microscope (50× magnification);

Grade 1: trace growth, that is, the growth is visible to the naked eye, but the growth coverage is less than 10%;

Grade 2: growth coverage is within a range of 10% to 30% (light growth);

Grade 3: growth coverage is within a range of 30% to 60% (moderate growth);

Grade 4: growth coverage is within a range of 60% or above to full coverage (severe growth).

The test results of the mold-inhibiting property are shown in Table 2 below.

TABLE 2
The test results of the mold-inhibiting property of Example 1

| Sample | | |
|---|---|---|
| No. | Mold Degree | Mold Grade |
| Example 1 | Trace growth: the growth is visible to the naked eye, but | Grade 1 |
| | the growth coverage is less than 10% | |

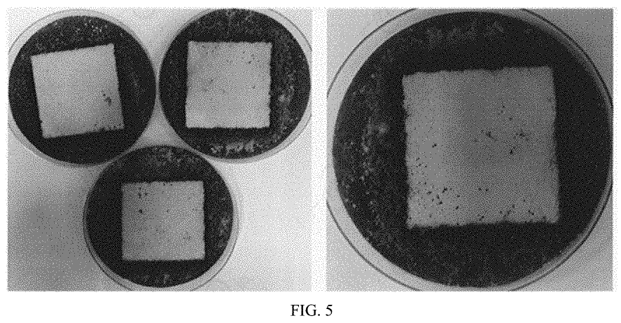

In addition, FIGS. 4 and 5 show respectively the pictures of the samples of Example 1 and Comparative Example 1 of the present disclosure after 28 days of mold-inhibiting property test. It can be seen by comparing FIG. 4 and FIG. 5 that, the holes which indicates the mold growth in the sample from Example 1 after 28 days of mold-inhibiting property test was much less than that in the sample from Comparative Example 1. With reference to FIGS. 4 and 5 and the Table 1 and Table 2 provided above, it can be seen that the coating material of the present disclosure has excellent antibacterial and mold-inhibiting properties.

In the description of the present disclosure, the description with reference to the terms “an embodiment”, “some embodiments”, “exemplary embodiment”, “example”, “specific example”, “some examples” or the like means specific features, structures, materials or characteristics described in connection with the embodiment or example are included in at least one embodiment or example of the present disclosure. In the present specification, the schematic representations of the above terms do not necessarily refer to the same embodiment. Moreover, the specific features, structures, materials, or characteristics described may be combined in a suitable manner in any one or more embodiments or examples. Directional words such as “upper”, “lower”, “inside”, “outer”, etc., used in embodiments of the present disclosure are used for description based on the accompanying drawings and should not be understood as a limitation on the embodiments of the present disclosure.

While the embodiments of the present disclosure have been shown and described, it will be understood by those skilled in the art that the various modifications, changes, substitutions and variations of the embodiments may be made without departing from the spirit and scope of the present disclosure. The scope of the present disclosure is defined by the appended claims and their equivalents.

What is claimed is:

1. A heat exchanger, comprising:
a metal base defining a heat exchange channel for flowing at least one of a refrigerant and a coolant therein; and
a coating layer coated at least a part of an outer surface of the metal base;
wherein the coating layer comprises sol particles and an antibacterial material, the sol particles comprise silica, and the antibacterial material comprises a rare earth element oxide.

2. The heat exchanger according to claim 1, wherein the sol particles further comprise titanium dioxide, and a content of the silica is greater than a content of the titanium dioxide.

3. The heat exchanger according to claim 1, wherein the coating layer is of a single layer with a hydrophilic surface, and a static contact angle between the coating layer and water is less than or equal to 10°.

4. The heat exchanger according to claim 1, wherein at least part of the silica is a hydrophilically modified silica having a particle size in nanoscale.

5. The heat exchanger according to claim 1, wherein a content of the sol particles is greater than a content of the antibacterial material, and a particle size of the rare earth element oxide is in nanoscale.

6. The heat exchanger according to claim 1, wherein the heat exchanger is a micro-channel heat exchanger, the metal base comprising:
a first header defining a first inner cavity;
a second header defining a second inner cavity; and
a plurality of heat exchange tubes connecting between the first header and a second header, each heat exchange tube defining a third inner cavity in fluid communication with the first inner cavity and the second inner cavity;
wherein the first inner cavity, the second inner cavity and the third inner cavity forms the heat exchange channel.

7. The heat exchanger according to claim 6, wherein a length direction of the first header is parallel to a length direction of the second header, a length direction of one of the heat exchange tubes of the plurality of heat exchange tubes is perpendicular to the length direction of the first header and the second header; and
the plurality of heat exchange tubes are arranged along the length direction of the first header, a length dimension of the one heat exchange tube being greater than a width dimension of the heat exchange tube, and the width dimension of the one heat exchange tube being greater than a thickness dimension of the heat exchange tube.

8. The heat exchanger according to claim 6, wherein the third inner cavity defines a plurality of micro channels.

9. The heat exchanger according to claim 6, wherein said metal base comprises a plurality of fins each sandwiched between two adjacent heat exchange tubes, and at least part of an outer surface of the first header, either adjacent heat exchange tube and at least one of the fins of the plurality of fins being coated with the coating layer.

10. The heat exchanger according to claim 9, wherein the coated fin is a corrugated fin extending along a length direction of the adjacent heat exchange tube, the fin comprising:
a plurality of fin units located between two adjacent heat exchange tubes;
a plurality of wave crests connecting with one of the two adjacent heat exchange tubes; and
a plurality of wave valleys connecting with an opposite one of the two adjacent heat exchange tubes;
wherein the wave crests and the wave valleys are retained to the two adjacent heat exchange tubes.

11. The heat exchanger according to claim 1, wherein an outer surface of the metal base has an uneven rough surface, a roughness of the rough surface characterized in that Ra satisfies the following relationship: 0.5 μm≤Ra≤10 μm, and the coating layer is arranged to cover the rough surface at least partially.

12. The heat exchanger according to claim 11, wherein the metal base is made of aluminum or an aluminum alloy, and the rough surface of the metal base is formed by sandblasting.

13. A coating material used to a heat exchanger, comprising a sol and an antibacterial material,
wherein the sol comprises sol particles, the sol particles comprise silica, and the antibacterial material comprises a rare earth element oxide.

14. The coating material according to claim 13, wherein the coating material comprises 98 to 99.5 parts by mass of the sol and 0.5 to 2 parts by mass of the antibacterial material.

15. The coating material according to claim 13, wherein the sol particles further comprises titanium dioxide, and a content of the silica is greater than a content of the titanium dioxide.

16. The coating material according to claim 15, wherein the sol is a mixed hydrophilic sol comprising a hydrophilically modified silica sol and a titanium dioxide sol.

17. The coating material according to claim 13, wherein at least part of the silica is a hydrophilically modified silica having a particle size in nanoscale.

18. The coating material according to claim 13, wherein a content of the sol particles is greater than a content of the antibacterial material, and a particle size of the rare earth element oxide is in nanoscale.

19. The coating material according to claim 13, wherein the sol comprises a solvent comprising at least one of methanol, ethanol and isopropanol.

20. A thermal management system, comprising:
a compressor;
a first heat exchanger connecting with the compressor;
a second heat exchanger connecting with the compressor; and
a throttling device connecting between the first heat exchanger and second heat exchange;
at least one of the first or second heat exchanger comprising:
a metal base defining a heat exchange channel for flowing at least one of a refrigerant and a coolant therein; and
a coating layer coated at least a part of an outer surface of the metal base; wherein the coating layer comprises sol particles and an antibacterial material, the sol particles comprise silica, and the antibacterial material comprises a rare earth element oxide.
